(19) United States
(12) Patent Application Publication
(10) Pub. No.: US 2018/0192481 A1
(43) Pub. Date: Jul. 5, 2018

(54) METHOD AND APPARATUS FOR INSTALLING AND REMOVING A SLEEVE

(71) Applicant: MASCHINENFABRIK Koeppern Gmbh & Co. KG, Hattingen (DE)

(72) Inventors: Eggert DE WELDIGE, Velbert Langenberg (DE); Magnus HUELTER, Hattingen (DE); Joerg EHRKAMP, Hueckeswagen (DE)

(21) Appl. No.: 15/125,743

(22) PCT Filed: Dec. 19, 2014
(86) PCT No.: PCT/EP2014/078844

§ 371 Date: Sep. 26, 2016

(30) Foreign Application Priority Data
Apr. 11, 2014 (DE) 102014105164.5

(51) Int. Cl. H05B 6/14; B02C 4/30; B23P 11/02; B30B 11/16; B30B 3/00; H05B 6/10; H05B 6/42; H05B 6/44

(52) U.S. Cl. CPC H05B 6/145; B02C 4/305; B23P 11/025; H05B 6/44; B30B 3/005; H05B 6/101; H05B 6/42; B30B 11/165

(57) ABSTRACT

The invention relates to a method for removing a roller tire (3) shrink fitted to a roller core (2) of a roller-press roller (1) where the roller tire is expanded by heating and pulled off the roller core. This method is characterized in that the roller tire is inductively heated with an induction coil (4).

The invention relates to a method for removing a roller tire shrink fitted to a roller core of a roller-press roller where the roller tire is expanded by heating and pulled off the roller core. In addition, the invention relates to a method for mounting such a roller tire on a roller core by shrink fitting.

Roller-press rollers within the context of the invention are rollers of a roller press, particularly a high-pressure roller press for the (high-pressure) comminution of material or for the briquetting or compacting of material. Such a roller press generally has two roller-press rollers that rotate in opposite directions. Briquetting or compacting compresses the granular bulk material between the rolls. For this purpose, the roller tire is generally provided on its outer surface with press tools, for example mold cavities for briquetting or compacting. For high-pressure comminution, the roller tire is typically configured with a wear-resistance coating.

It is common in practice to fix roller tires on a roller core and/or a shaft by shrink fitting. For this purpose, the roller tire is heated to a certain temperature so that it expands. Next, the roller tire is fitted over the core. As it cools, the roller tire shrinks such that it becomes fixed to the roller core by a shrink fit. In practice, the roller tire is typically heated during mounting in a suitable oven. However, this approach creates problems in the removal, and accordingly the expansion thereof by heat, since the entire roller-press roller needs to be put in the oven. In addition, the removal by heat expansion only works if the core is prevented from expanding as well. Consequently, a temperature gradient must be created between the roller tire and the core. As such, the core must be prevented from heating up at the same time.

For this reason, in practice, gas burners are frequently used in the past for the heating process. Such a heating with open flames, however, is disadvantageous for various reasons —particularly that an appropriate gas supply must be ensured on site. As a result, it is typically necessary to stockpile a large number of gas cylinders.

For this reason, resistance-heating has been suggested as an alternative, with corresponding heating bands or heating blankets. The invention proceeds from this suggestion.

The object of the invention is to create a method by means of which it is possible to quickly and easily remove a roller tire from a roller core of a roller-press roller.

In addressing this problem, the invention teaches, in a method in the class for removing a roller tire shrink fitted to a roller core of a roller-press roller, that the roller tire is heated by induction using at least one induction coil (through which current flows).

The invention proceeds here from the recognition that a roller tire can be very quickly and effectively heated to the required temperatures if heating is inductive. For this purpose, an alternating magnetic field is generated in the roller tire via an induction coil through which flows an alternating current, the roller tire being made of an electrically conductive material. This alternating magnetic field induces eddy currents in the roller tire; and if the roller tire is made of a ferromagnetic material, it also induces cyclic magnetization losses. Compared to heating in an oven, this method has the great advantage that the roller tire, and particularly the assembled roller-press roller, with the roller tire, need not be put in an oven. The method is consequently particularly well suited for removing by heat expansion roller tires mounted on a roller core. It is also possible to avoid the disadvantages that arise in connection with gas burners. Because no gas cylinders and no oven are necessary, the invention can also be carried out in remote areas. Compared to heating based on resistance, inductive heating has the advantage that heat is generated directly in the roller tire, and need not first be transmitted to the roller tire by thermal conductance. As a result, heating is particularly rapid. The great advantage of this is that it is possible to prevent excessive heating of the roller core itself. The heat is consequently generated rapidly and in a targeted manner exactly where it is needed—specifically in the roller tire. In addition, inductive heating has the advantage compared to heating based on resistance that it does not rely on good heat transfer, such that it is possible to achieve an effective heating even with uneven or structured surfaces. This is advantageous with structured surfaces, by way of example that are used with roller tires having abrasive elements, or also for example roller tires with briquetting tools. Such surfaces cannot be effectively heated by resistance heating due to the poor heat transfer. Inductive heating can be used particularly advantageously during removal of used roller tires by heat expansion because they have highly uneven surfaces due to wear. This is because inductive heating does not rely on a good heat transfer.

Inductive heating is fundamentally known from various fields of engineering. It is particularly used for joining and detaching interference fit assemblies—for example annular elements fixed to shafts, such as inner rings of roll bearings, for example (cf. DE 922 700 and DE 200 16 369 U1). Furthermore, the suggestion has been made, for mounting and removing rotor caps of generators, to heat the rotor cap inductively by placing one or more induction coils against the same, specifically with a higher frequency current with a working frequency of 5 to 25 kHz (cf. DE 195 32 848).

However, these considerations have not yet had any influence on the mounting and removal of roller tires for roller presses. Consequently, the focus of the invention is the use of the known induction heating process in the removal and mounting of roller tires for (high-pressure) roller presses. Because of the advantages described, the method according to the invention can be used particularly preferably in the removal of used roller tires that have uneven surfaces due to wear.

Even if the removal, and consequently the removal by heat expansion, of a roller tire is the focus of the invention, inductive heating is likewise suitable for the mounting, and consequently the shrink fitting, of the roller tire onto the roller core. The subject matter of the invention is therefore also a method for mounting a roller tire to a roller core of a roller-press roller where the roller tire is inductively heated using at least one induction coil (through which current flows). The invention proceeds in this case from the recognition that a system for induction heating can certainly be used not only for the removal by heat expansion, but likewise for the shrink fitting, without the need for structural modifications. The method according to the invention is particularly preferably used for mounting roller tires with structured surfaces.

Inductive heating is particularly suitable according to the invention because roller tires of (high-pressure) roller presses are thick-walled roller tires with a wall thickness of more than 100 mm, and particularly more than 200 mm. It has been shown that such thick-walled roller tires can be heated in a targeted manner significantly better by induction, and consequently can be removed by heat expansion and/or can be shrink-fit installed. It is particularly advantageous in this case that, despite the massive construction of such roller tires, a targeted heating of the roller tire is possible without the core being excessively heated. The temperature difference required for removal by heat expansion can therefore be created very easily. The outer diameter of such roller tires is typically more than 1000 mm, and particularly more than 1500 mm. The method according to the invention is consequently carried out for heavy components with large volumes.

It has further been shown that such components can be effectively heated in a targeted and particularly efficient manner if the induction coil is operated with an alternating current with a frequency of 1 kHz to 20 kHz, preferably 10 kHz to 15 kHz. The frequency and also the power can be adjusted in each individual case, taking into account the material and geometry.

Even though inductive heating already makes possible a very targeted heating of the roller tire itself, in practice it may be expedient to increase the temperature gradient between the roller tire and core by cooling the roller core during heating of the roller tire. For this purpose, it is suggested according to the invention that the roller core is cooled via a core hole by passing a cooling medium such as cooling water through the core hole. The invention proceeds in this case from the recognition that such roller-press rollers are typically provided with cooling systems anyway, because roller-press rollers are frequently cooled during operation. An existing core hole can be used according to the invention for cooling of the core during the removal or during the shrink fitting. However, it is also possible to specially include such holes (and/or comparable passages or recesses) for cooling.

The subject matter of the invention is also an apparatus for mounting and/or removing a roller tire according to a method of the type described above. Such an apparatus has at least one induction device having at least one induction coil that surrounds the roller tire, and at least one current supply for the induction coil.

According to a first embodiment, the induction coil is formed by a flexible induction cable of a predetermined length that is wound around the roller tire flexibly. Such a flexible inductor has the advantage that it can be adapted to different geometries, particularly different roller tire diameters. In addition, such flexible induction cables can be transported easily, which is advantageous in the case of a variable use on-site. Such induction cables are typically cooled; they are preferably provided with their own water cooling. The induction cables can be made of copper wire, that is for example cooled by water. There is the option in this case of winding the entire roller tire with a single induction cable. However, it can also be advantageous to work with multiple, separate induction coils. In this case, multiple induction cables are wound around the roller tire, and each individual induction coil forms its own induction coil that surrounds a respective roller-tire segment. Each individual induction coil can have with a separate respective current supply, and consequently can be controlled individually such that different regions can also be brought to different temperatures. Different degrees of energy can be introduced over the length of the roller tire by multiple coils. This can be used to compensate for, by way of example, greater emission losses at the edge, or greater energy requirements in the center. This can be advantageous for rolls in which, for example, more heat “runs off” into the core in the center due to the construction with roller pins. The use of multiple induction cables also enables easy adaptation to different roller tire widths. As such, even long roller tires, for example, can be heated when only short induction cables or weak induction assemblies are available.

In a second embodiment, the induction coil a rigid induction coil that is slid over the roller tire (with radial clearance) and/or into which the roller tire is inserted. The induction coil therefore forms a predetermined, rigid construction into which a roller tire can be inserted. A corresponding winding is dispensed with in this case. However, the induction coil is then adapted to a corresponding outer diameter and/or diameter range of a roller tire. As described in the context of the flexible induction cable, multiple induction coils can be used (next to each other), even in the case of rigid induction coils, to achieve the described advantages.

According to a further suggestion of the invention, thermal insulation surrounds the roller tire within the induction coil. When flexible cables are used, thermal insulation can therefore initially be applied to the outer surface of the roller tire. The coil is then wound on this insulation.

It should be understood that such an induction device is provided with a suitable current supply that is likewise configured with a suitable (automated) control. The current supply can be configured with a frequency inverter so that it is possible to set, and optionally to vary, the working frequency. The temperature can be monitored, and heating can accordingly be control with or without feedback via temperature sensors. By way of example, thermocouples can be used for this purpose.

The invention is described below in greater detail with reference to drawings illustrating one embodiment, wherein:

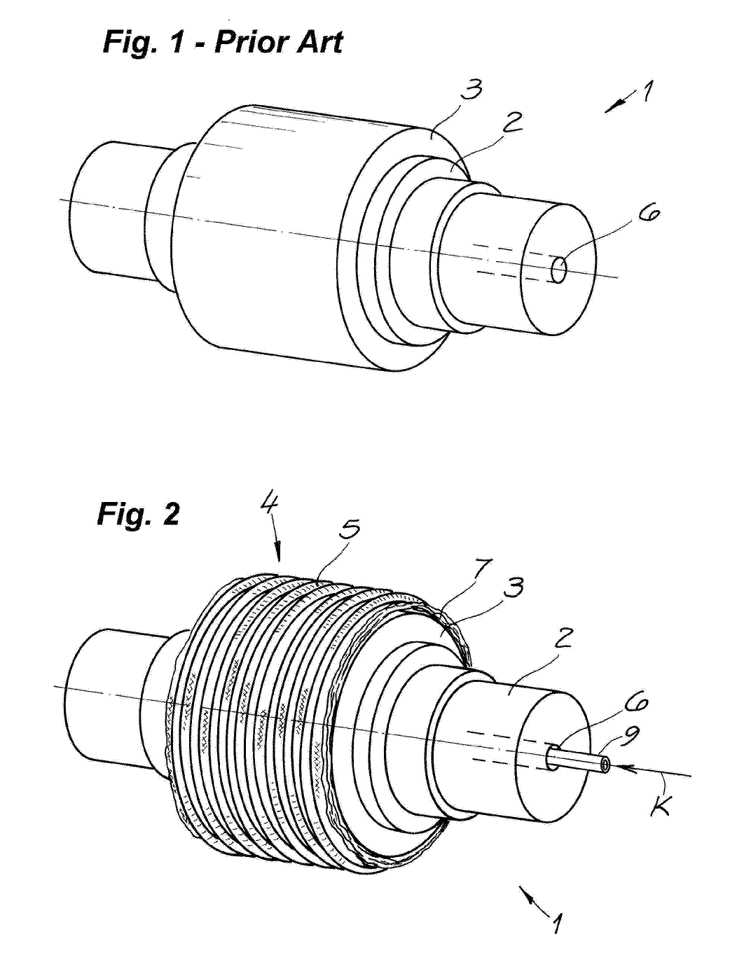

FIG. 1 shows a known roller-press roller with roller core and roller tire,

FIG. 2 shows the roller-press roller according to claim 1 with the mounted induction apparatus for removing the roller tire by heat expansion, in a first embodiment, and

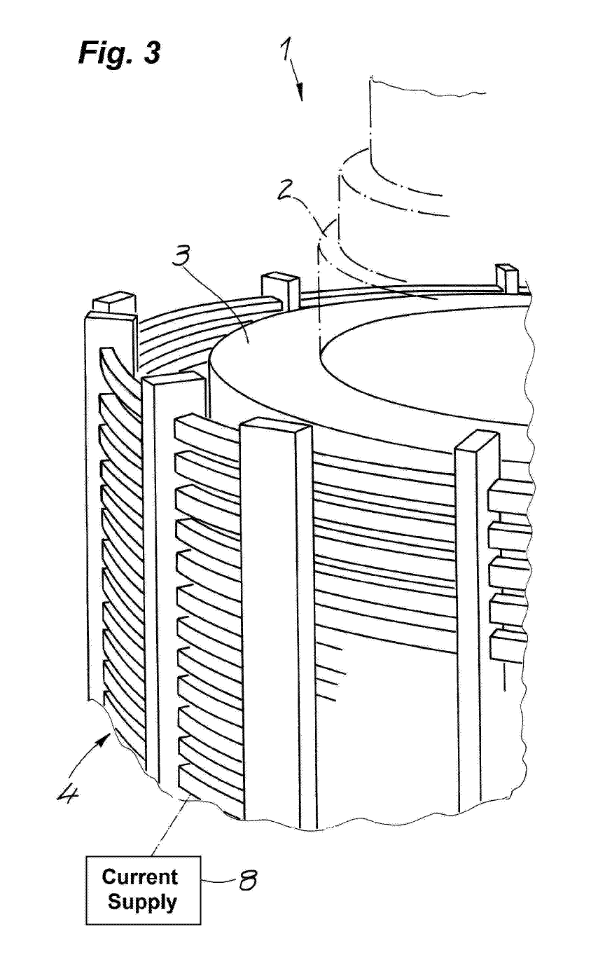

FIG. 3 shows a modified embodiment of the invention.

FIG. 1 shows a known roller-press roller 1 that has a roller core 2 and a roller tire 3 shrink fitted onto same. Such a roller tire 3 can be provided with a wear-resistant coating, and/or with briquetting or compacting tools. Details are shown.

Heating by induction is used to remove the shrink fitted roller tire. For this purpose, an induction device that has an induction coil 4 and an unillustrated current supply, is used. The induction coil 4 surrounds the roller tire 3 such that the roller tire 3 is heated inductively via the induction coil through which current flows. During heating of the roller tire 3, it expands, and specifically to a greater degree than the roller core 2, such that the roller tire 3 can be detached and pulled off the roller core 2.

In the embodiment shown in FIG. 2, the induction coil 4 is formed by a flexible induction cable 5 that is wound around the roller tire 3. This induction cable 5 can be cooled by water.

In addition, FIG. 2 shows that the roller core 2 is likewise cooled—specifically by water cooling. For this purpose, cooling water K flows through an existing core hole 6. However, the cooling water K does not flow through the core hole 6 directly. Rather, a cooling lance (not illustrated) is inserted into the core, and cooling water flows through the lance. In any case, additional cooling of the roller core 2 particularly effectively prevents heating of the roller core 2, such that the desired temperature gradient is established very quickly. In addition, it can also be seen in FIG. 2 that the induction coil 4 surrounds the roller tire 3 with a thermal insulation situated in-between. The flexible induction cable 5 is wound on an insulation layer 7 that surrounds the roller tire 3.

FIG. 3 shows an alternative embodiment in which the induction coil 4 is not formed by a flexible induction cable, but rather a rigid induction coil. The roller tire 3 and/or the roll 1 with the roller tire is consequently inserted into this rigid induction coil 4 and/or into the interior space thereof. In this case, the induction coil 4 is therefore adapted to the outer diameter of the roller tire being shrink fitted or removed by heat expansion.

Even though the figures show the removal by heat expansion of a mounted roller tire by way of example, the induction devices shown can likewise be used to heat the roller tire in the course of the shrink fitting of the roller tire.

1. In a method for removing a roller tire shrink fitted to a roller core of a roller-press roller or for fitting the tire to the core, where the roller tire is expanded by heating and pulled off the roller core or slid onto the core and cooled to contract it, the improvement comprising the step of inductively the tire with at least one induction coil to expand or contract it.

2. (canceled)

3. The method according to claim 1, wherein the roller tire is thick-walled and has a wall thickness of more than 100 mm.

4. The method according to claim 1, wherein the roller tire has an outer diameter of more than 1000 mm.

5. The method according to claim 1, wherein the induction coil is operated with an alternating current with a frequency of 1 kHz to 20 kHz.

6. The method according to claim 1, further comprising the step of:
cooling the roller core during or prior to heating of the roller tire.

7. The method according to claim 6, wherein the roller is cooled by flowing a cooling medium through the roller core via a core hole.

8. An apparatus for removing a roller tire from and/or mounting a roller tire onto a roller core by respectively heating the tire and sliding it off the core or cooling the roller core to shrink it onto the core, the apparatus comprising:
at least one induction device having at least one induction coil that surrounds the roller tire and at least one current supply for the induction coil.

9. The apparatus according to claim 8, wherein the induction coil is formed by a flexible induction cable that is wound around the roller tire.

10. The apparatus according to claim 8, wherein the induction coil a rigid induction coil that is slid over the roller tire.

11. The apparatus according to claim 8, wherein the induction coil is provided with a water cooler.

12. The apparatus according to claim 8, wherein the apparatus has multiple separately controllable induction coils distributed adjacent one another over an axial length of the roller.

13. The apparatus according to claim 8, further comprising:
a thermal insulator surrounding the roller tire and surrounded by the induction coil.
